(19) United States
(12) Patent Application Publication
(10) Pub. No.: US 2010/0053678 A1
(43) Pub. Date: Mar. 4, 2010

(54) PRINTING APPARATUS AND PRINTING CONTROL METHOD

(75) Inventors: Yasuhiko Yoshihisa, Matsumoto-shi (JP); Takao Oizumi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/549,318

(22) Filed: Aug. 27, 2009

(30) Foreign Application Priority Data
Aug. 28, 2008 (JP) 2008-219774

(51) Int. Cl. G06F 15/00

(52) U.S. Cl. 358/1.15

(57) ABSTRACT

A printing apparatus includes: a reading section which performs scanning in a readable range; a flexible flat cable (FFC) which is connected to the reading section; a printing section which performs printing on the basis of readout data acquired through the flexible flat cable; and a positioning section which positions the reading section at a predetermined position other than the readable range.

Priority is claimed under 35 U.S.C. §119 to Japanese Application No. 2008-219774 filed on Aug. 28, 2008, which is hereby incorporated by reference in its entirety.

### BACKGROUND

1. Technical Field

The present invention relates to a printing apparatus and a printing control method.

2. Related Art

In flatbed scanners, a read-out image signal, which is acquired by a line sensor mounted on a carriage, is transmitted to an image signal process circuit through an FFC (a Flexible Flat Cable). The FFC extends from the carriage in one of the moving directions of the carriage, is curved and loops back, extends along the bottom of a carriage moving space in the other moving direction of the carriage, and extends to the outside of the carriage moving space. The FFC is a cable having a repulsive force against bending. When the height of the carriage moving space is low, the curved looped-back portion comes into contact with the inside of a glass plate for placing an original document thereon and scratches the glass plate, thereby causing readout errors. In order to cope with such a problem, Japanese Unexamined Patent Application Publication No. 2004-348074 discloses a technique for separating the FFC from the glass plate by employing a suppression section.

However, in this technical field, there is a high temperature storage test for electronic goods. The high temperature storage test is defined as a test for inspecting the thermal influence caused by high temperatures. In the test, the specimen is left in a high temperature environment for a long period of time, and subsequently it is evaluated whether the specimen can normally operate. The inventor of the invention conducted the high temperature storage test (a test where the specimen is left in environments at a plurality of temperatures in the range of 35 to 60° C. for a period of six days in consideration of an environment of the bottom of a ship) on the multi-function printer according to embodiments of the invention in consideration of a storage environment and a transport environment. Then, in a case of performing a control for stopping the carriage in the course of reading an image and restarting the reading, it was observed that there was discontinuity (a phenomenon in which an image is not continued at a joint portion) in the read-out image.

FIG. 12 is a graph in which the degree of the discontinuity (a deviation amount) caused by actually conducting the high temperature storage test is plotted. The drawing shows data representing two resolutions for two types of FFC-A and FFC-B. The resolutions are defined by scanning directions, one is 500 pixels (the vertical direction of A4 size is scanned in 500 steps), and the other is 1500 pixels (the vertical direction of A4 size is scanned in 1500 steps). As shown in the drawings, the deviation amount gradually increases as the temperature of the environment increases. In addition, it can be observed that the deviation amount becomes remarkable (the deviation amount exceeds a threshold value at which the discontinuity is visible to the human eye, and the threshold value is expressed as the visibility limit in the drawing) in the thermal range of 50 to 60° C. Consequently, it was discovered that there is a relationship between the high temperature storage and the discontinuity of the read-out image.

### SUMMARY

An advantage of some aspects of the invention is that it provides a printing apparatus having a reading section which does not cause disorder in a read-out image even in the case of high temperature storage, and a printing control method for the printing apparatus.

The printing apparatus according to an aspect of the invention includes: a reading section which performs scanning in a readable range; a flexible flat cable (FFC) which is connected to the reading section; a printing section which performs printing on the basis of the readout data acquired through the flexible flat cable; and a positioning section which positions the reading section at a predetermined position other than the readable range.

The readout scanning is defined as scanning which is performed in accordance with the readout instruction, is started from the predetermined standby position for waiting for the readout instruction, and is continued until the reading section returns to the predetermined standby position. The readable range is defined as a range in which the reading section performs scanning during the readout scanning. Specifically, the readable range is defined so as to include not only the scanning range during the actual reading of the readout target but also the scanning range accompanied with the scanning.

For example, the readable range may include the following ranges: a preliminary acceleration range required for preliminary acceleration for accelerating the reading section to a predetermined speed at which the reading section performs the reading of the readout target while being moved at the predetermined speed when the reading instruction is issued; a deceleration range in which the reading section is moved until being stopped after the reading of the readout target in the readable range is terminated; and a scanning range in which after the readout scanning of the readout target is terminated in order to eliminate backlash in a driving mechanism for driving the reading section, the reading section is moved farther from the standby position in a direction opposite to the readout scanning direction by a predetermined distance, and the reading section is positioned at the standby position by reversing the drive direction of the drive mechanism.

Specifically, the predetermined position is a certain position outside of the readable range. Examples of the position include: a position farther from the position, at which the reading section is stopped by deceleration, in the readout scanning direction; a position farther from the position, at which the drive direction of the drive mechanism is reversed in order to eliminate backlash, in the readout scanning direction; and the like. Accordingly, the shape of the FFC stored at high temperatures becomes different from the shape of the FFC in the course of the readout scanning. As a result, it is possible to minimize the influence on the image reading from the deformation and deterioration of the FFC stored at high temperatures.

In this aspect of the invention, it is preferable that the readable range be a scanning range in which the reading section performs scanning in the largest readable range from a standby position, at which the reading section is on standby for instruction on scanning, and returns to the standby position. The reason being that sometimes scanning is performed only in a predetermined portion of the whole scannable range when the readout target is scanned. Consequently, even in the printing apparatus having a reading section capable of specifying various scanning ranges, the shape of the FFC stored at high temperatures is not likely to coincide with the shape of the FFC in the course of the readout scanning. As a result, it is possible to minimize the influence on the image reading from the deformation and deterioration of the FFC stored at high temperatures.

In this aspect of the invention, it is preferable that the flexible flat cable be curved, loop back and be connected to the reading section. In addition, it is also preferable that the position of the curved looped-back portion changes in accordance with the scanning position of the reading section. In addition, it is also preferable that the curved looped-back portion of the flexible flat cable, in a state where the reading section is at the predetermined position, does not overlapped with the curved looped-back portion of the flexible flat cable in a state where the reading section is in the readable range.

The curved looped-back portion is a portion in which the FFC interconnecting the connection portion and the reading section is curved at a halfway position and thus the extending direction of the FFC changes. The extending direction, which is changed by the curved looped-back portion, may form various angles of, for example, 90°, 180°, or the like. Furthermore, the curved looped-back portion of the FFC, in the state where it is at the predetermined position, may overlap with the curved looped-back portion located in the preliminary acceleration range, the deceleration range, and the like over the scanning range in which the reading section performs scanning in the largest possible readable range from the standby position, at which the reading section is on standby for instruction on scanning, and returns to the standby position. The reason being that it is difficult to influence the readout scanning.

In this aspect of the invention, it is preferable that readout data which is read by the reading section be stored in a storage section through the flexible flat cable. In addition, it is also preferable that the scanning of the reading section be stopped when the amount of the readout data exceeds the storage capacity of the storage section. In addition, it is also preferable that the readout data in the storage section be transmitted to a different storage region after the scanning operation is stopped. In addition, it is also preferable that the scanning be restarted from the position at which the scanning was stopped after the transmission of the data.

In particular, in the situation in which the discontinuity tends to occur in the image reading, it is considered that the curved looped-back portion, during the period before the readout scanning is restarted after the scanning of the reading section has been temporarily stopped, may overlap with the curved looped-back portion of the FFC in the state where it is at the predetermined position. In order to restart the scanning after the temporary stop, the reading section should retreated and loop back to the readout interruption position. However, at this time, when the curved looped-back portion overlaps, this influences the readout scanning. Accordingly, when this aspect of the invention is applied to a device configuration in which the reading section restarts the reading after the readout interruption, it is possible to obtain excellent operational effects.

The invention may be embodied in the following forms: a reading device in which the printing section is removed from the configuration of the printing apparatus; a printing system having the printing apparatus; a control method having a process corresponding to the configuration of the above-mentioned device; a program for allowing the computer to execute the function corresponding to the configuration of the above-mentioned device; and a computer-readable recording medium in which the program is recorded. The reading device, the printing system, the printing control method, the print control program, and the medium storing the program also may have the same effects and advantages mentioned above. It is apparent that the configurations according to the aspect of the invention can be applied to the system, the method, the program, and the recording medium.

### BRIEF DESCRIPTION OF THE DRAWINGS

The invention will be described with reference to the accompanying drawings, wherein like numbers reference like elements.

FIG. 1 is an exterior perspective view illustrating a multi-function printer.

FIG. 2 is a diagram illustrating a specific configuration of a reading section.

FIG. 3 is a diagram illustrating a specific configuration of a printing section.

FIG. 4 is a diagram illustrating a specific configuration of a control section.

FIG. 5 is a sectional view illustrating the reading section which is cut vertically in a scanning direction.

FIGS. 6A, 6B, and 6C are diagrams illustrating positional relationships between the winding position and the curved looped-back range of a flexible flat cable.

FIG. 7 is a diagram illustrating an image region in which discontinuity is caused during a high temperature storage test.

FIG. 8 is a diagram schematically illustrating the positional relationship between the winding positions and the curved looped-back portion in the case of high temperature storage in a state where a carriage is disposed at a transport position P1.

FIG. 9 is a diagram schematically illustrating the positional relationship between the winding positions and the curved looped-back portion in the case of high temperature storage in a state where the carriage is disposed at a transport position P2.

FIG. 10 is a flowchart of a readout scanning process.

FIG. 11 is a flowchart of a printing process.

FIG. 12 is a graph in which a degree of the discontinuity (a deviation amount) during the high temperature storage test is plotted.

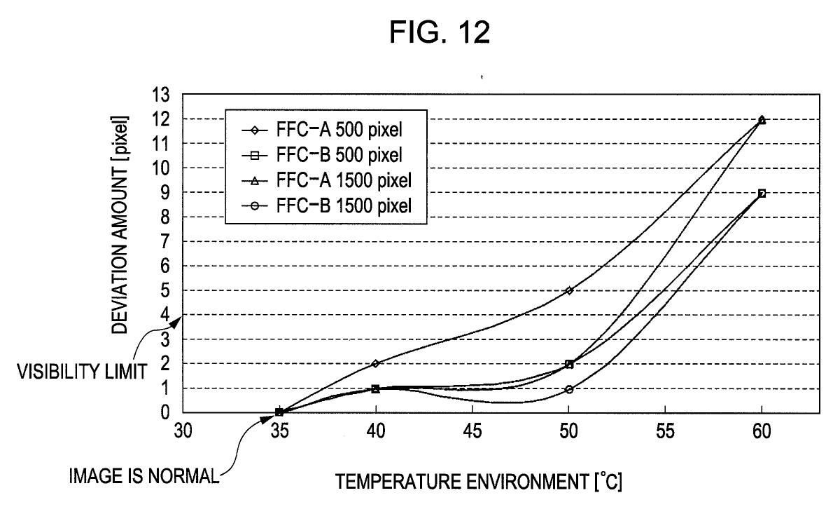

### DESCRIPTION OF EXEMPLARY EMBODIMENTS

Hereinafter, an embodiment of the invention will be described in the following order: 1. a configuration of a printing apparatus; 2. a mechanical configuration of a reading section; 3. a readout process of the reading section; 4. a printing process of a printing section; 5. delivery preparation process; and 6. conclusion.

### 1. Configuration of Printing Apparatus

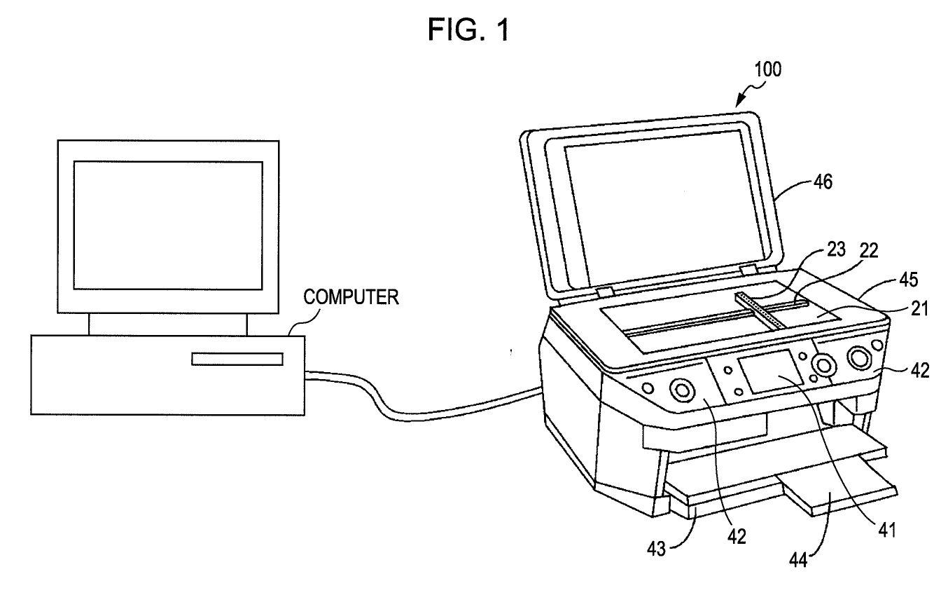

FIG. 1 is an exterior perspective view illustrating a multi-function printer 100 as a printing apparatus according to the embodiment. In the drawing, the multi-function printer 100 is enclosed by a casing 45 formed in a substantially rectangular shape, and a cover 46 is attached to the upper portion of the casing 45 which is able to be freely opened and closed. In a state where the cover 46 is opened, there is an original platen 21 made of glass. A guide section 22 which extends in a lengthwise direction is provided inside the original platen 21. The guide section 22 is engaged with a carriage 23 and is configured to be able to move along the guide section 22 while maintaining its oriented direction. The carriage 23 is a rod-like member oriented in a direction orthogonal to the extending direction of the guide section 22. A plurality of imaging portions 23a is attached on the upper surface of the carriage 23. Accordingly, by moving the carriage 23 along the guide section 22 while receiving light reflected from an original document placed on the original platen 21, it is possible to obtain image information from the original document surface. The carriage 23 including the imaging portions 23a constitutes the reading section.

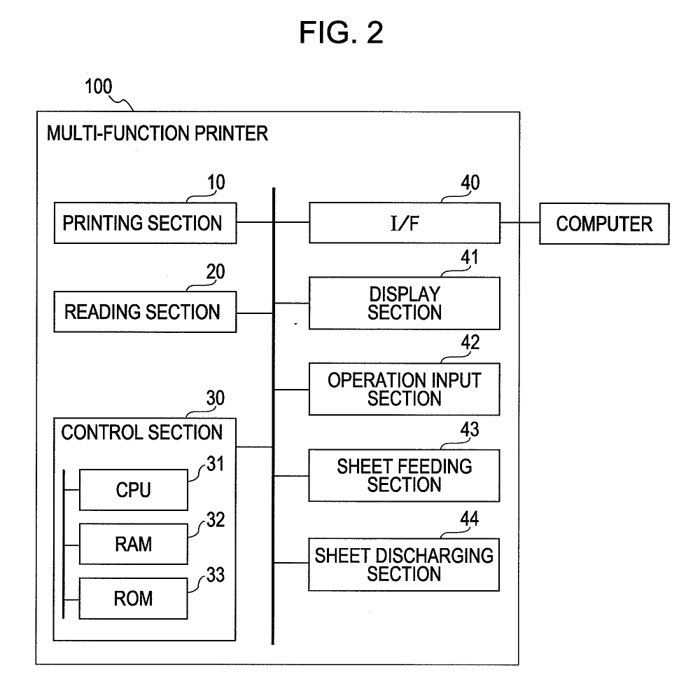

FIG. 2 is a block diagram illustrating a configuration of the multi-function printer 100. In the drawing, the multi-function printer 100 is a so called multi-functional type printing apparatus which has a print function, a scanning function, and a copy function, and in which a printing section 10 and the reading section 20 are integrally formed with a control section 30 for controlling those sections. Specifically, the multi-function printer 100 outputs the image data, which is read by the reading section 20, to the connected computer in accordance with the instructions from the control section 30, allows the printing section 10 to perform the printing based on the image data which is input from the connected computer and the like, or performs the copy function by sending, directly or with the aid of the computer, the image data, which is read by the reading section 20, to the printing section 10 so as to print the image. The multi-function printer 100 includes an interface (I/F) 40 which is connected to an I/F of the computer, and outputs the readout data of the reading section 20 and the print data to the printing section 10 through the I/F 40.

Furthermore, an ink jet type printer as a printing section 10 is exemplified in the following description. However, it is apparent that it is possible to employ a laser type printer, a thermal sublimation type printer, and the like. In the following description, a scanner is exemplified which performs scanning to acquire surface information by using a line sensor (1-dimensional sensor) as a reading section 20. However, it may be possible to employ a scanner which performs scanning to acquire the surface information or line information by using point sensors (0-dimensional sensor) or a scanner which performs scanning to acquire the surface information by using a surface sensor (2-dimensional sensor).

A display section 41 and an operation input section 42 are disposed on the upper side of the front of the casing 45. The display section 41 is formed by, for example, an LCD (a Liquid Crystal Display). The display section 41 displays a setting screen, operation items (print, reading, copy, and the like), operation situation, and the like of the multi-function printer 1 00. The operation input section 42 is formed of, for example, buttons, dials, sliders, and the like. By operating the operation input section 42, a user can fetch the setting screen of the multi-function printer 100 to input the setting or can fetch an operation selection screen to instruct operations.

A sheet feeding section 43 for feeding print papers and a sheet discharging opening 28 for discharging print papers are provided on the lower side of the front of the casing 45. The sheet feeding section 43 contains the plurality of print papers, and feeds the print papers, one by one, to the printing section 10 inside the multi-function printer 100 in accordance with the requests from the control section 30. Then, the sheet discharging section 44 discharges the paper printed by the printing section 10 to the outside of the multi-function printer 100.

### Reading Section

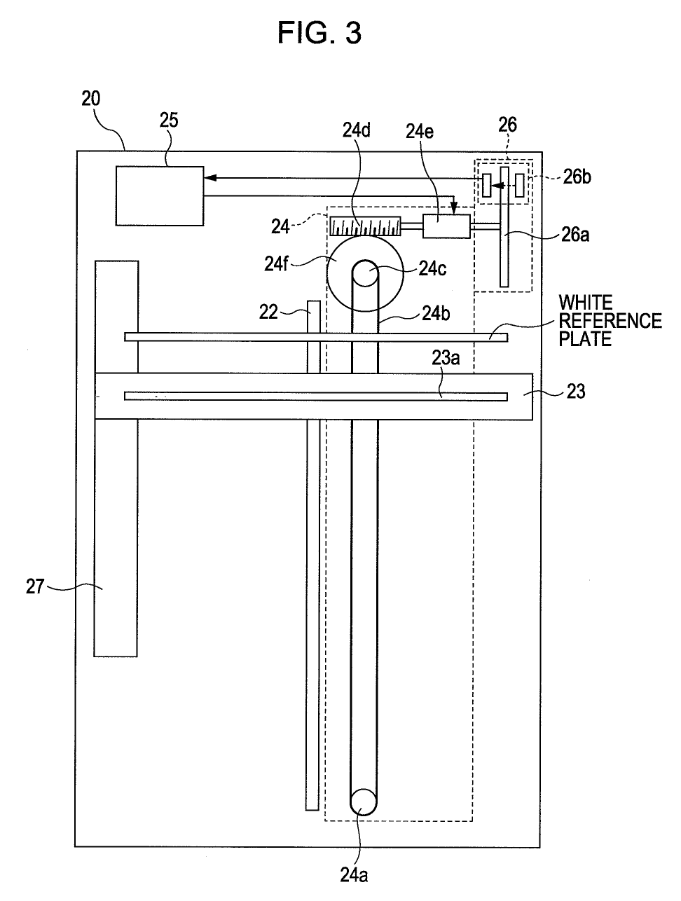

FIG. 3 is a diagram illustrating a specific configuration of the reading section 20. The transparent glass plate (the original platen 21) covers the upper surface of a box-like region, which opens upward and has a flat bottom at a shallow depth, in the reading section 20, thereby forming a scanning space S in which the carriage 23 is able to move. The scanning space S is formed to be longer vertically and be shorter horizontally, in order to effectively scan original documents such as an A4 original document having an aspect ratio which is not 1:1. The scanning space S of the reading section 20 includes the carriage 23, a carriage moving portion 24, a carriage displacement detector 26, and an FFC (Flexible Flat Cable) 27.

The carriage moving portion 24 transports the carriage 23 from one end to the other end of the scanning space S in the scanning direction while maintaining the orientation direction of the carriage 23. Specifically, the carriage moving portion 24 may include: for example, a direct current motor (DC motor) 24e; a worm gear 24d which is bonded to an output shaft of the DC motor 24e; a spur gear 24f which rotates at a predetermined rotation ratio and is in meshing engagement with the worm gear 24d; a pulley 24c which is disposed on the one end of the scanning space S and is bonded to the spur gear 24f, a pulley 24a which is disposed on the other end of the scanning space S; a timing belt 24b which is stretched between the pulley 24c and the pulley 24a; and the guide rail (the guide section) 22 which extends from one end to the other end in the scanning direction in substantially the center of the scanning space S in the horizontal direction. Furthermore, instead of the DC motor 25e, a stepping motor may be used.

The carriage 23 is fixed so as to be able to slide while its length wise direction substantially coincides with a direction perpendicular to the guide section 22. In addition, the carriage 23 is fixed on the timing belt 24b which is disposed in parallel to the rail. When the DC motor 24e is driven, the timing belt rotates through the worm gear 24d, the spur gear 24f, and the pulley 24c. The carriage 23 moves in the scanning space S in engagement with the rail in accordance with the rotation amount of the timing belt which rotates around the pulleys 24a and 24c.

An optical reduction system or a contact image sensor system may be used as the imaging portions 23a attached to the carriage 23. When the optical reduction system is used, light from a light source (a white light lamp and the like) is irradiated on the surface of the original document, and the light reflected from the surface of the original document is reflected and converged by a mirror and a lens. Then, the converged light is guided into image pickup elements (CCDs, that is, Charge Coupled Devices and the like), and is converted into electric signals depending on the amount of light received. When the contact image sensor system is used, light beams from RGB color light sources (LEDs and the like) are sequentially changed and irradiated on the original document. Then, the reflected light beams are sequentially received by the image pickup elements (for example, a rod lens array in which LEDs, lenses, and sensors are integrally formed in rod shapes having the same length and are in direct contact with each other) and is converted into electric signals depending on the amount of light received.

The carriage displacement detector 26 detects the displacement of the carriage 23 in the scanning space S. More specifically, the carriage displacement detector 26 may be formed of, for example, a rotary encoder including a disc 26a and a photo interrupter 26b. In the photo interrupter 26b, a light emitting portion and a light receiving portion are disposed to face each other with the disc surface interposed therebetween. The center of the disc 26a is bonded to the output shaft of the DC motor 24e. In addition, the disc 26a has slits formed at a predetermined interval in a circumferential direction. The disc 26a rotates with the rotation of the DC motor 24e. The slit portion of the disc 26a passes light from the light emitting portion of the photointerrupter, and a portion other than the slit portion blocks the light. That is, the light receiving portion of the photointerrupter receives light having the number of pulses depend on the rotation number of the DC motor 24e, and generates electric signals corresponding to the pulse light. Furthermore, two photointerrupters are provided to be spaced away from the disc 26a at a predetermined angle (an angle which is not a half of the circumference of the disc 26a, for example, π/2). With such a configuration, it is possible to detect the rotation direction of the DC motor 24e, and it is possible to improve the measurement precision of the rotation amount of the disc 26a by using the two photointerrupters.

The read-out image signal which is acquired by the imaging portions 23a mounted on the carriage is transmitted to the control section 30 through the FFC (Flexible Flat Cable) 27. The FFC 27 extends from the carriage 23 in one of the moving directions of the carriage, is curved and loops back, extends along the bottom of the scanning space S in the other moving direction of the carriage, and extends to the outside of the scanning space S. The FFC 27 is fixed at the extended portion thereof and at the portion thereof connected to the carriage 23.

### Printing Section

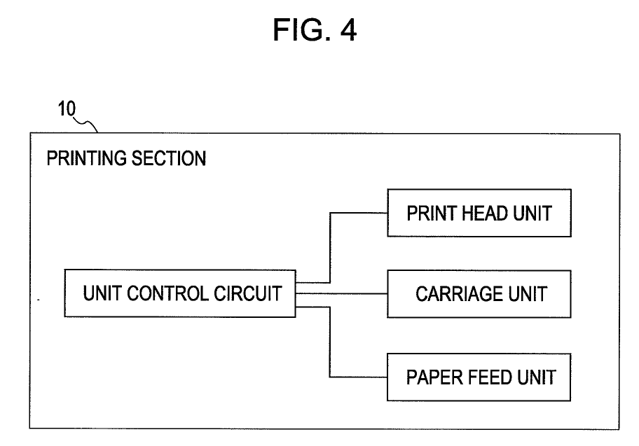

FIG. 4 is a diagram illustrating a specific configuration of the printing section 10. The printing section 10 includes: a print head unit 11 for ejecting color inks; a carriage unit 12 for reciprocating the print head unit 11 in a direction orthogonal to the paper feed direction of the print paper; a paper feed unit 13 for transporting the print paper in the sub-scanning direction which is the paper feed direction; and a unit control circuit 14 for driving the units 11 to 13 in response to the instructions from the control section 30.

When the printing section 10 receives the print data from the computer, the control section 30 controls the units (the print head unit, the carriage unit, and the paper feed unit), thereby performing printing based on the print data. The print head unit 11 includes the print head 11 a formed of a plurality of nozzles. The print head unit 11 generates a pattern of voltage applied to piezo elements when apply voltage data corresponding to the print data is input to the print head unit 11 from the unit control circuit 14, and thus drives piezo elements to press and expand ink chambers of nozzles, thereby ejecting ink droplets from the nozzles.

The carriage unit 12 reciprocates the print head unit 11 in the main scanning direction by using a motor. The carriage unit 12 reciprocates in synchronization with the ejection timing so that color ink dots ejected from a print head 1 la are attached on predetermined positions on the print paper in the main scanning direction in accordance with the instructions from the unit control circuit 14.

The paper feed unit 13 transports the paper in the sub-scanning direction. The paper feed unit 13 includes a transport roller, and feeds a predetermined amount of the papers at appropriate times according to the reciprocation of the print head unit.

### Control Section

The control section 30 includes a CPU 31, a ROM 32, and a RAM 33. The control section performs a calculation process by using the CPU 31 in the RAM 33 as a work area while appropriately executing a control program, which is stored in the ROM 32, in the RAM 33 and controls the reading section 20 or the printing section 10 in accordance with the control program, thereby achieving a scanner function, a printer function, and a copy function for the multi-function printer 100.

### 2. Mechanical Configuration of Reading Section

Hereinafter, the position of the carriage 23 in the scanning space S will be described. Furthermore, the position of the carriage 23 is defined as the position at which the imaging portions 23a of the carriage 23 reads an image.

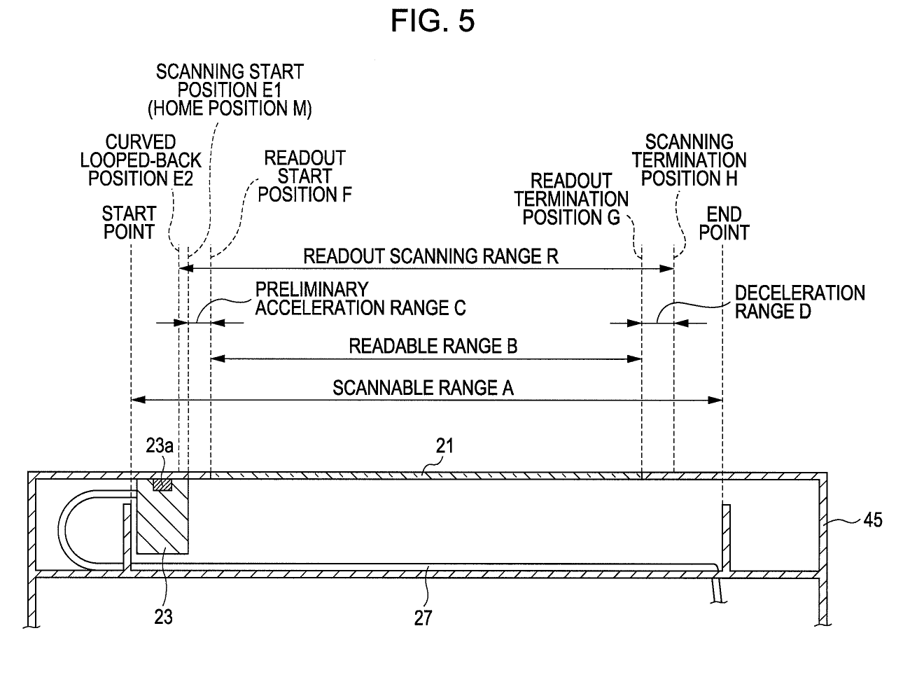

FIG. 5 is a sectional view illustrating the reading section which is cut vertically in the scanning direction. As shown in FIG. 5, in the description, the portions of the scanning space S of the carriage 23 in the scanning direction are defined as follows.

The scannable range A is defined as the whole range from the start point of the scanning space S to the end point thereof. The readable range B is defined as the range in which the imaging portions 23a are able to read an image of the original document placed on the original platen. The preliminary acceleration range C is defined as the range in which the readout scanning is started near the front side of the readout area and preliminary acceleration (run start) is performed when the readout scanning is performed. The deceleration range D is defined as the range in which the carriage 23 is decelerated behind the readout area when the readout scanning is performed.

The scanning start position E1 is defined as the position from which the preliminary acceleration is started in the preliminary acceleration range C. The curved looped-back position E2 is defined as the position which is set to be closer to the start point of the scannable range A than the scanning start position E1 in order to eliminate backlash. The readout start position F is defined as the position which is the start point of the readable range B and simultaneously is the end point of the preliminary acceleration range C. The readout termination position G is defined as the position which is the end point of the readable range B and simultaneously is the start point of the deceleration range D. The deceleration termination position H is defined as a position which is the end point of the deceleration range D.

Furthermore, when the readout start position F is located at the start point of the readable range B, the scanning start position E1 corresponds to a so-called home position M.

The readout scanning range R is defined as a scanning range in which the reading section performs the readout scanning in the largest readable range (the readable range B) from a standby position (the home position M) for waiting instructions on the readout scanning, and returns to the standby position. That is, the readout scanning range R is defined as a range in which the reading section performs scanning from the home position M in the preliminary acceleration range C, the readable range B, and the deceleration range D, moves back to the curved looped-back position E2 therefrom, and returns to the home position M from the curved looped-back position E2.

The readout start position F is defined as the front position in the glass surface area of the original platen 21 when the scanning is started form the home position M. In addition, the readout start position F is also defined as the readout interruption position located right before the scanning is restarted once the scanning has been interrupted and restarted. The readout start position is also defined as the halfway position of the scanning area when the scanning is performed from the position in the middle of the scanning area. Accordingly, the preliminary acceleration range C shifts in accordance with the readout start position F. Likewise, the readout termination position G also shifts in accordance with the size of the original document and the range to be read.

Here, in the present application, there is a problem in that there is discontinuity and disorder in the read-out image. Thus, the cause of the problem will be considered in the following section. It can be inferred that the cause of the discontinuity in the read-out image is, for example, that the curved looped-back portion of the FFC 27 is not smoothly moved in the vicinity of the winding portion of the FFC 27. That is, originally, the curved looped-back portion of the FFC 27 has to be smoothly shifted in accordance with the movement of the carriage, but the curved looped-back portion is not smoothly shifted in the vicinity of the winding portion of the FFC 27. This generates a force which operates against the force of the moving of the carriage, thereby obstructing the movement of the carriage. In this case, it can be inferred that microscopic deviation corresponding to the allowance in the engagement portion between the carriage and the rail is likely to occur in the orientation direction of the carriage. In addition, it is also can be inferred that deviation, which corresponds to the amount of backlash of the toothed wheels constituting the carriage moving mechanism, is likely to occur in the carriage position. Under the inferences described above, the inventor of the present application conducts tests as follows. Needless to say, the other causes are not disregarded.

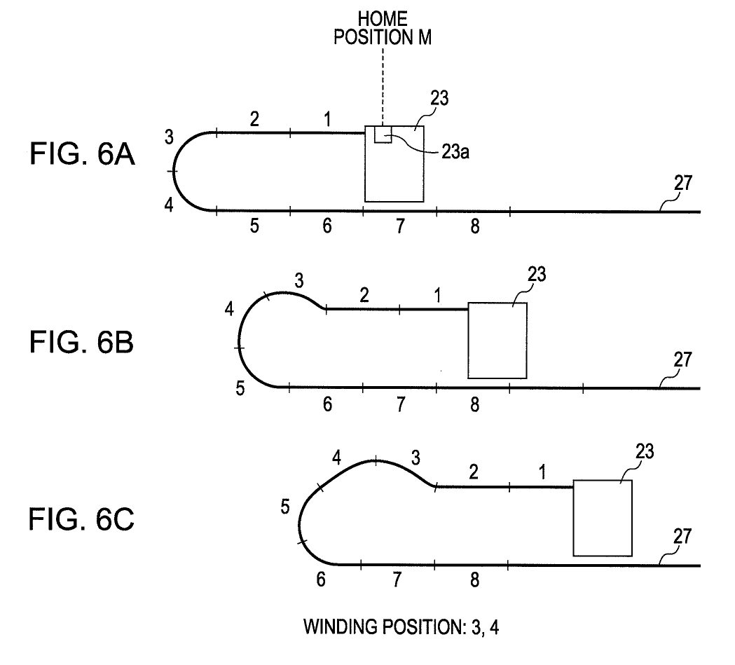

FIGS. 6A, 6B, and 6C are diagrams illustrating positional relationships between the winding position and the curved looped-back range of the FFC during the readout scanning, after a high temperature storage test is conducted in the state where the carriage 23 is disposed at the home position M. The curved looped-back range is defined as the range in which the extending direction of the FFC 27 from the carriage is changed from the negative X direction to the positive X direction by causing curvature in the middle of the FFC 27. In the drawing, the predetermined lengths of the FFC 27 are respectively indicated by the reference numbers, and it is shown how the portions corresponding to the respective numbers are curved and move.

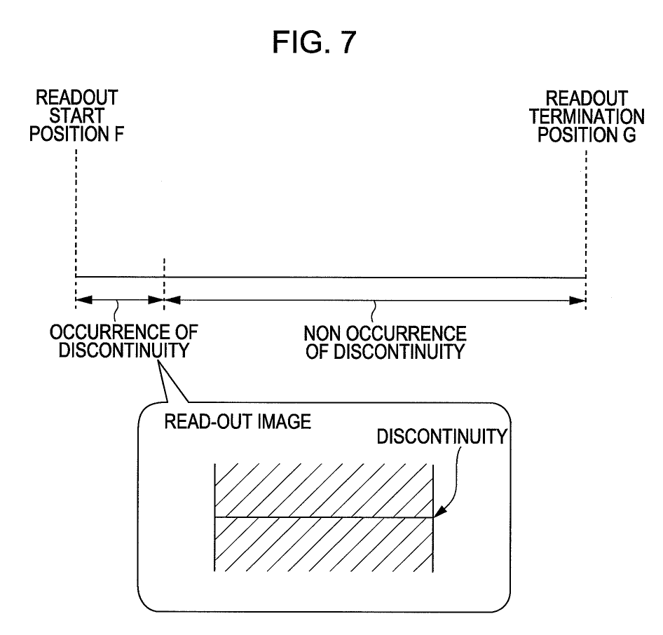

As shown in FIG. 6A, when the carriage 23 is at the home position M, the winding position coincides with the curved looped-back range. As the carriage 23 moves in the scanning direction due to the starting of the readout scanning as shown in FIG. 6B, the winding position gradually deviated from the curved looped-back range. However, as shown in FIG. 6B, it can be inferred that there is deviation in the scanning position since the carriage 23 is subjected to stress, which is different from that in the case where the winding portion does not exist, when the winding position and the curved looped-back range partially overlap. Further, as shown in FIG. 6C, it can be inferred that the force required for forming the curved looped-back range in the FFC 27 is returned to normal when the winding position is removed from the curved looped-back range. These inferences are verified by the result shown in FIG. 7.

FIG. 7 shows the image region in which there is discontinuity when the high temperature storage test is conducted in the state where the carriage is disposed at the home position M. As shown in the drawing, it can be inferred that the region, in which the reading discontinuity occurs, is in a predetermined range from the home position M, and corresponds to a range in which the winding position of the FFC 27 enters the curved looped-back range and then is removed from the curved looped-back range. The reading discontinuity does not occur after the winding position of the FFC 27 is removed from the curved looped-back range.

For this reason, in the embodiment of the invention, the winding position of the FFC 27 is adjusted so as not to overlap with the curved looped-back range during the readout scanning. Specifically, when the carriage 23 is left in the possible high temperature situations such as transporting and storing in the storage, it may be possible to adopt a method in which the carriage 23 is compulsorily disposed outside of the scanning start position of the readout region or is disposed outside of the scanning termination position of the readout region. Hereinafter, in such a disposition of the carriage 23, the former is referred to as a transport position P1, and the latter is referred to as a transport position P2.

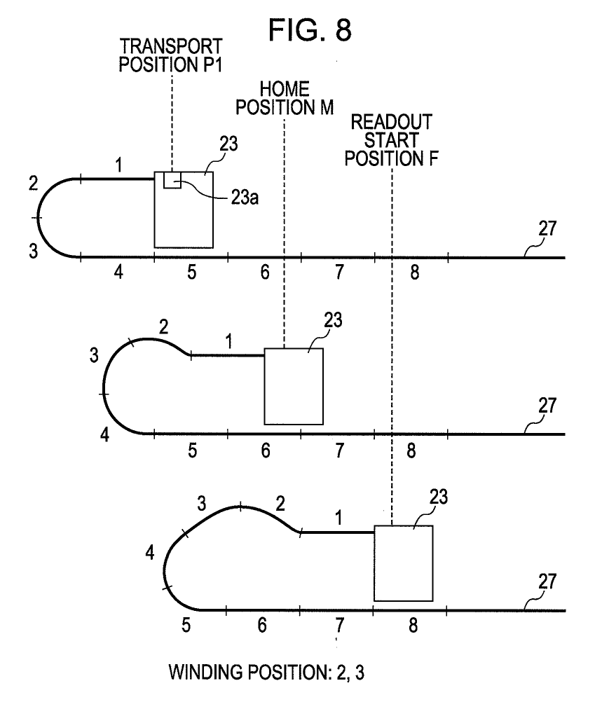

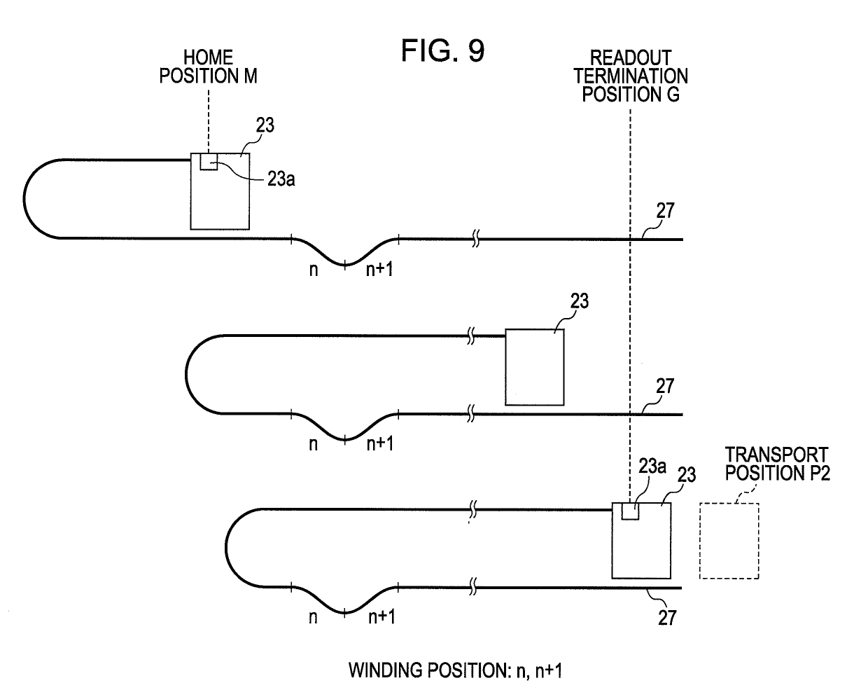

FIG. 8 is a diagram schematically illustrating the positional relationship between the winding positions and the curved looped-back portion in the course of the readout scanning of the reading section 20 in the case of high temperature storage in the state where the carriage 23 is disposed at the transport position P1. FIG. 9 is a diagram schematically illustrating the positional relationship between the winding positions and the curved looped-back portion in the course of the reading operation of the reading section 20 in the case of high temperature storage in the state where the carriage 23 is disposed at the transport position P2.

First, as shown in FIG. 8, when the FFC is stored at high temperatures at the transport position P1, the winding positions 2 and 3 is out of the curved looped-back range until the carriage 23 is moved to the readout start position and then starts the reading. Accordingly, even when the reading is interrupted in the course of the readout scanning process to be described later and the process is performed for returning the carriage 23 to the readout interruption position, the discontinuity in the read-out image data will scarcely occur. As shown in FIG. 9, when the FFC is stored at high temperatures at the transport position P2, the winding positions n and n+1 enter the curved looped-back range after the carriage 23 reaches the readout termination position. Accordingly, the reading discontinuity will scarcely occur in the course of the readout scanning. The readout process of the reading section 20 using the FFC, which is stored at high temperatures in a state where the carriage 23 is disposed at any one of the transport positions P1 and P2, will be described in the following section.

### 3. Reading Process of Reading Section

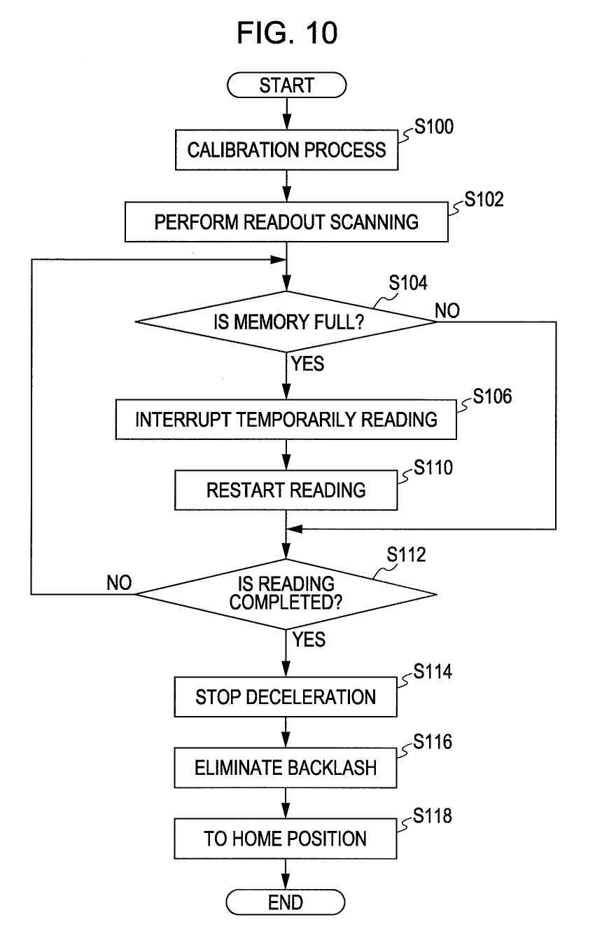

FIG. 10 is a flowchart of a readout scanning process which is executed when the scanning is performed on the original document in accordance with the instructions from the control section 30. The readout scanning process is started by a user putting the original document on the original platen 21 and then operating the operation button of the operation input section 42 or a readout scanning command is input from a computer which is connected via the I/F 40. The operation performed by the user or the readout scanning command input from the computer includes information which specifies the resolution in the main scanning direction (the lengthwise direction of the carriage) and the sub-scanning direction (the moving direction of the carriage), the number of colors, the number of gradation levels, and the scanning range.

When the process is started, the various calibrations are performed in step S100. The various calibrations are defined to include white reference corrections (an uneven brightness correction, a light amount correction, and the like) and a black reference correction. The calibrations are performed by using a white reference plate disposed between the home position M and the readout start position F. First, the control section 30 takes an image with the light source of the imaging portions 23a turned off, and performs the black reference correction on the basis of the imaging result. Then, the control section 30 takes an image of the white reference plate disposed between the readout start position F and the home position M while moving the carriage 23 toward the readout start position F. The reflectance of the white reference plate is known. The white reference plate is attached onto the inner side of the upper wall of the scanning space S so that the white surface thereof faces downward. As described above, the control section 30 takes black and white images by using the imaging portions 23a before reading the original document, and corrects any difference in sensitivity therebetween caused when the same light amounts are received on the basis of the images acquired by the image pickup elements. When the above calibration is completed, the movement of the carriage 23 is temporarily stopped.

In step S 102, the readout scanning of the original document, that is, the readout scanning from the readout start position F to the readout termination position G is executed. Specifically, the control section 30 instructs the DC motor 24e to move the carriage 23 while accelerating the carriage 23 to the readout start position F. During that time, the carriage 23 is accelerated by an open loop control until the movement speed of the carriage 23 approaches a predetermined speed, is accelerated to the predetermined speed by changing the control to a feedback control (for example, PID (Proportional-Integral-Derivative) control and the like) when the movement speed thereof approaches the predetermined speed, and is moving at the predetermined speed in the carriage moving direction. The predetermined speed is a speed depending on the resolution in the main scanning direction. When the carriage 23 reaches the readout start position F, the readout data is acquired at a predetermined time interval by controlling the imaging portions 23a while moving the carriage 23. The acquired readout data is temporarily stored in a predetermined storage region in the RAM 33. The stored data is output to the computer and the like for each unit amount (for example, for each data unit corresponding to several lines, for each data unit corresponding to one sheet of the original document, for each maximum data unit which can be stored in the storage area, and the like).

In step S104, it is determined whether or not the predetermined storage region (the storage section) in the RAM 33 is full (whether or not the storage capacity of the storage section has been exceeded). That is, it is determined whether or not the memory is full. Whether or not the memory is full is determined by a memory full signal which is output by the memory. If the memory is full, the flow proceeds to step S106. If the memory is not full, the flow proceeds to step S110.

In step S106, the control section 30 temporarily interrupts the readout scanning of the original document. Specifically, the control section 30 temporarily stops the acquisition of the readout data from the imaging portions 23a, and stops the movement of the carriage 23 by stopping the DC motor 24e. At this time, the control section 30 temporarily stores the information on the readout interruption position, at which the readout scanning is temporarily interrupted, in the RAM 33. Furthermore, the DC motor 24e is stopped by stopping supply of the direct current electric power to the DC motor 24e. However, even when the supply of the direct current electric power is stopped, the DC motor 24e is slightly rotates more due to inertia and is stopped by friction. Hence, the actual stop position of the carriage 23 is a position slightly shifted from the readout interruption position. The control section 30 detects the stop position through the control circuit 25 by counting the number of pulses output by the photointerrupter 26b. In step S106, the control section 30 outputs (transmits) the image data of the RAM 33 to the computer and the like (other storage regions) until the amount of the image data in the RAM 33 becomes smaller than a predetermined amount. Then, when the amount of the image data in the RAM 33 is smaller than the predetermined amount, the flow proceeds to step S110, and the reading is restarted.

In step S110, the readout scanning is restarted from the readout interruption position. The readout start position F at the time of restarting the reading is the readout interruption position. The carriage 23 is moved near the front of the readout start position F, and is accelerated at the predetermined speed until reaching the readout interruption position from the position by performing the preliminary acceleration. Then, the reading is restarted from the readout interruption position at the predetermined speed. Here, the distance which the carriage 23 is returned is the total distance obtained by adding the difference between the readout interruption position and the stop position to the distance required for the preliminary acceleration. At this time, since the winding position of the FFC 27 does not overlap with the curved looped-back portion, the carriage 23 is not subjected to the abnormal stress when the reading is restarted. Accordingly, deviation scarcely occurs between the actual position of the carriage 23 and the readout interruption position, and thus discontinuity in the read-out image scarcely occurs.

In step S112, it is determined whether or not the reading is terminated. This determination is based on the number of pulses output by the photointerrupter 26b. If the current position, which is obtained on the basis of the number of pulses, passes over the readout termination position G, it is determined that the reading is terminated. Then, the flow proceeds to step 114, and the carriage 23 is decelerated and stopped. In contrast, if the current position does not pass over the readout termination position G, it is determined that the reading is not completed. Then, the process from step S106 is repeated.

In step S116, the carriage 23 is moved to the curved looped-back position by reversing the moving direction thereof. In this movement, the carriage 23 is accelerated by the open loop control until the movement speed approaches the predetermined speed. Then, the carriage 23 is accelerated to the predetermined speed by changing the control to the feedback control (the PID control and the like) when the movement speed approaches the predetermined speed, and subsequently is moving at the predetermined speed. Then, the carriage 23 is decelerated to a predetermined speed by changing the control to the open loop control when approaching the curved looped-back position. Subsequently, the carriage 23 is stopped at the curved looped-back position by changing the control to the feedback control.

By reversing the drive of the DC motor 24e after the carriage 23 is stopped at the curved looped-back position, backlash is eliminated and deviation scarcely occurs between the displacement detected on the basis of the output of the photointerrupter and the actual displacement in the carriage movement thereafter. The curved looped-back position is set on the front side of the home position M by a distance required for eliminating backlash. Backlash occurs in the drive portion of the carriage moving portion 24 for transferring the driving force of the DC motor 24e to the carriage 23.

In step S118, the control section 30 moves the carriage 23 to the home position M. Accordingly, preparation for the following readout scanning is completed.

### 4. Printing Process of Printing Section

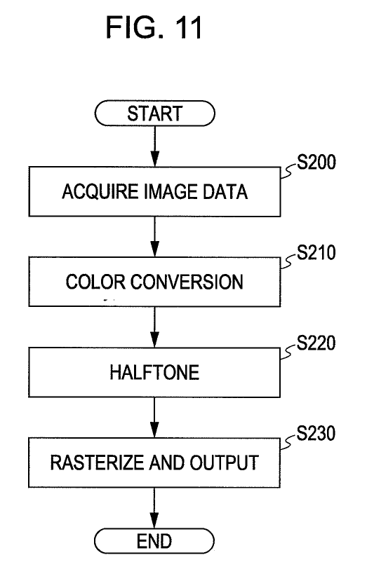

FIG. 11 is a flowchart of the printing process which is executed in the printing section 10 in accordance with the instructions from the control section 30. In the printing section, the printing process is executed based on the readout data acquired by the reading section or the printing process based on the print data input from the computer and the like through the I/F 40.

When the process is started, the control section 30 acquires the image data D from the reading section 20 or the computer connected through the I/F 40 in step S200. The image data D is dot matrix data which specifies colors of pixels by representing component colors of R (red), G (green), and B (blue) as gradation, and wherein the color system prescribed by sRGB standard is employed. Needless to say, it may be possible to employ various data such as JPEG image data based on YCbCr color system, image data based on CMYK color system, and the like. In addition, the control section may input the image data by using not only the computer but also a digital still camera (not shown), a memory card, and the like which are connected to the multi-function printer 100. Furthermore, in step S200, the image data D is subjected to a predetermined resolution conversion process so as to be adjusted to output resolution of the printing section as the need arises.

In step S210, color conversion is performed to convert the color system of the image data D into the color system of the ink colors used by the printing section. Specifically, the control section 30 converts the RGB data of the pixels of the image data D into gradation levels (CMYK data) for each CMYK with reference to an unillustrated color conversion look-up table (LUT) which is previously stored in the ROM 32 and the like. The color conversion LUT is a table which is recorded by uniquely associating the CMYK data with predetermined reference points (RGB data) in the sRGB color space. The arbitrary RGB data can be converted into the CMYK data by appropriately performing interpolation calculation with reference to the color conversion LUT. In the embodiment, the values of the CMYK before and after the color conversion are represented by 256 gradations.

In step S220, a halftone process is executed for converting the CMYK gradation levels of dots in the CMYK data and representing those as distribution of the dots of ink droplets. As a result, it is possible to obtain halftone data which specifies ON and OFF states of the dots of the ink colors to the pixels of the CMYK data.

In step S230, the halftone data is converted into raster data for driving the nozzles of the print head, and the converted data is sequentially output to the printing section 10. In the printing section 10, an unillustrated ejection nozzle array used as an ink ejection device is mounted on the print head. In the nozzle array, the plurality of ejection nozzles is arranged in parallel in the sub-scanning direction. Thus, data, which are separated from each other by several dots in the sub-scanning direction, are simultaneously used. Accordingly, the rasterization is performed which sequentially sorts data, which will be simultaneously used, among head drive data arranged in the main scanning direction so that these data are simultaneously subjected to buffering in the printing section 10. Here, the main scanning direction is the direction of the reciprocating of the print head, and the sub-scanning direction is the direction of the feeding of the papers. After the rasterization process, the print data is generated, in which predetermined information such as image resolution is added, and is output to the printing section 10 through the I/F 40, thereby performing printing.

Then, a unit control circuit receiving the raster data reciprocates the carriage in the main scanning direction, intermittently moves the print paper by a predetermined amount in the sub-scanning direction, and makes the print head unit eject ink, thereby performing printing and completely forming one print image.

### 5. Delivery Preparation Process

In the embodiment, by using the above-mentioned method for moving the carriage to the transport position P, the control section 30 is able to perform a delivery preparation process. The delivery preparation process according to the embodiment is performed as a control process by the control section 30, and is executed at the time of a predetermined operation input.

The movement of the carriage to the transport position P is not needed in a usage environment which is not a high temperature storage state. Accordingly, in order to prevent the process from being unintentionally executed by a user in a normal usage environment for the user, a so-called concealing command different from the normal operation input is appropriate for the predetermined operation input. When the delivery preparation process is started by performing the predetermined operation input, the control section supplies power to the DC motor 24e so as to drive the motor, and move the carriage 23 to the transport position P.

Since the transport position P is the end, which is out of the readout scanning range R, in the scannable range A, it is not necessary to consider the stop position. Accordingly, the control section 30 controls the DC motor 24e in an optional method such as the open loop control and the feedback control, and moves the carriage 23 to the limit of the scannable range A thereof. Then, it is determined whether or not the movement to the transport position P is completed. Specifically, it is determined whether or not the transport position P is reached on the basis of the displacement detected by the carriage displacement detector. If the movement to the transport position P is not completed, the movement is continued. In contrast, if the movement to the transport position P is completed, the power of the multi-function printer is turned off, and the process is terminated.

When the normal power is supplied after the delivery preparation process is terminated in such a manner, the above-mentioned readout process is executed. Then, the carriage 23 is moved from the transport position P to a readout calibration position, and is disposed in the readout scanning range R in the flow of the normal readout process. Needless to say, it may be possible to adopt a configuration in which a usage preparation process of moving the carriage 23 from the transport position P to the home position M can be executed and the user can execute the usage preparation process before usage.

### 6. Conclusion

As described above, the multi-function printer 100 according to the embodiment includes: the carriage 23 for performing the readout scanning in the serial readout scanning range; the FFC (Flexible Flat Cable) 27 connected to the carriage 23; the positioning section for positioning the carriage 23 at the transport position P1 or the transport position P2 which are out of the serial readout scanning range; and the printing section 10 for performing printing on the basis of the readout data acquired through the FFC 27. With such a configuration, it is possible to provide a multi-function printer and printing apparatus having the reading section which does not cause disorder in the read-out image even in the case of high temperature storage.

Furthermore, the invention is not limited to the above-mentioned embodiments and the modified examples. In addition, the scope of the invention involves: a configuration in which the various components, which are defined by aspects of the invention and their equivalents, that is, which are disclosed in the above-mentioned embodiments and the modified examples, may be replaced with each other or combination of those may be modified; and a configuration in which the various components, which are disclosed in the known techniques, the above-mentioned embodiments, and the modified examples, may be replaced with each other or combination of those may be modified.

What is claimed is:

1. A printing apparatus comprising:
a reading section which performs scanning in a readable range;
a flexible flat cable (FFC) which is connected to the reading section;
a printing section which performs printing on the basis of readout data acquired through the flexible flat cable; and
a positioning section which positions the reading section at a predetermined position other than the readable range.

2. The printing apparatus according to claim 1, wherein the readable range is a scanning range in which the reading section performs the scanning in the largest readable range from a standby position, at which the reading section is on standby for instruction on the scanning, and returns to the standby position.

3. The printing apparatus according to claim 1,
wherein the flexible flat cable is curved and loops back and is connected to the reading section,
wherein a position of the curved looped-back portion changes in accordance with the scanning position of the reading section, and
wherein the curved looped-back portion of the flexible flat cable, in a state where the reading section is at the predetermined position, does not overlap with the curved looped-back portion of the flexible flat cable in a state where the reading section is in the readable range.

4. The printing apparatus according to claim 1,
wherein readout data which is read by the reading section is stored in a storage section through the flexible flat cable,
wherein the scanning of the reading section is stopped when the amount of the readout data exceeds the storage capacity of the storage section,
wherein the readout data in the storage section is transmitted to a different storage region after stopping, and
wherein the scanning is restarted from the position at which the scanning is stopped after the transmission.

5. A method for controlling a printing apparatus including a reading section which performs scanning in a readable range, a flexible flat cable which is connected to the reading section, and a printing section which performs printing on the basis of the readout data acquired through the flexible flat cable, the printing control method comprising:
positioning the reading section at a predetermined position other than the readable range.
